(19) United States
(12) Patent Application Publication
(10) Pub. No.: US 2009/0264128 A1
(43) Pub. Date: Oct. 22, 2009

(54) TERMINAL STATION, BASE STATION, RADIO COMMUNICATION SYSTEM, AND COMMUNICATION CONTROL METHOD

(75) Inventor: Toshiaki TOMISAWA, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: MITSUBISHI ELECTRIC CORPORATION, Chiyoda-ku (JP)

(21) Appl. No.: 12/207,080

(22) Filed: Sep. 9, 2008

(30) Foreign Application Priority Data
Apr. 16, 2008 (JP) 2008-106996

(51) Int. Cl. H04Q 7/20

(52) U.S. Cl. 455/436

(57) ABSTRACT

An uplink quality information collecting unit transmits, when there is no uplink data transmission from a terminal station for a predetermined time, dummy data to a base station that is currently connected to the terminal station, and collects uplink-quality information that is generated by transmitting the dummy data to the base station. A handover determining unit determines whether to perform a handover based on the uplink-quality information collected by the uplink quality information collecting unit.

### BACKGROUND OF THE INVENTION

1. Field of the Invention

The present invention relates to a terminal station having a handover function and a base station, configuring a mobile communication system.

2. Description of the Related Art

Researchers have actively studied a high-speed mobile station using wireless local area network (wireless LAN) technologies. They have particularly focused on a technology to implement high-speed, accurate, and seamless handover in a situation that the mobile station is moving.

Japanese Patent Application Laid-open No. 2003-318804, for example, discloses a radio-communication control method of preventing occurrence of call breaks in a situation a mobile station and a base station are connected to each other via radio. In the radio-communication control method, the mobile station re-transmits control data to the base station depending on quality of downlink communications in a direction from the base station to the mobile station. More particularly, when the mobile station detects deterioration of the downlink communications, the mobile station adjusts parameters concerning re-transmission of the control data, and re-transmits the control data based on the adjusted parameters. The parameters includes number of re-transmissions, interval between the re-transmissions, and electric-power level at which the control data is re-transmitted.

Japanese Patent Application Laid-open No. 2005-323034 discloses a handover method of implementing effective radio communications. More particularly, the terminal station (mobile station) transmits a disconnect-request signal to the current base station, to which the terminal station is currently being connected, to perform handover. The number of re-transmissions of the disconnect-request signal is set to a level lower than usual. Thereby, it takes shorter time from detection of a next base station to which the terminal station is to be connected to start of connecting process, which shortens data break time due to handover.

In the conventional technologies disclosed in Japanese Patent Application Laid-open No. 2003-318804 and Japanese Patent Application Laid-open No. 2005-323034, however, the terminal station determines whether the re-connecting process or the handover process is to be performed based on an electric-power level of signals that is received from the base station solely. If the electric-power level decreases accidentally due to fluctuation of the electric power of signals received from the base station when the terminal station is inside a coverage area of the base station, there is possibility that the terminal station misunderstands that the communication quality deteriorates and determines that handover is to be performed in an unnecessary situation.

### SUMMARY OF THE INVENTION

It is an object of the present invention to at least partially solve the problems in the conventional technology.

According to an aspect of the present invention, there is provided a terminal station that makes up a radio communication system with a base station. The terminal station includes an uplink quality information collecting unit that transmits, when there is no uplink data transmission from the terminal station for a predetermined time, dummy data to a base station that is currently connected to the terminal station, and collects uplink-quality information that is generated by transmitting the dummy data to the base station and a handover determining unit that determines whether to perform a handover based on the uplink-quality information collected by the uplink quality information collecting unit.

Furthermore, according to another aspect of the present invention, there is provided a terminal station that makes up a radio communication system with a plurality of base stations. The terminal station includes an uplink quality information collecting unit that periodically transmits dummy data to a base station that a base station currently connected to the terminal station, and collects uplink-quality information that is generated by transmitting the dummy data to the base station and a handover determining unit that determines whether to perform a handover based on the uplink-quality information collected by the uplink quality information collecting unit.

Moreover, according to still another aspect of the present invention, there is provided a base station that makes up a radio communication system with a terminal station. The base station includes a downlink quality information collecting unit that transmits, when there is no downlink data transmission for a predetermined time, dummy data to a terminal station that is currently connected to the base station, and collects downlink-quality information that is generated by transmitting the dummy data to the terminal station and an information transmitting unit that transmits the downlink-quality information collected by the downlink quality information collecting unit to the terminal station, based on which the terminal station determines whether to perform a handover.

Furthermore, according to still another aspect of the present invention, there is provided a base station that makes up a radio communication system with a terminal station. The base station includes a downlink quality information collecting unit that periodically transmits dummy data to a terminal station that is currently connected to the base station, and collects downlink-quality information that is generated by transmitting the dummy data to the terminal station and an information transmitting unit that transmits the downlink-quality information collected by the downlink quality information collecting unit to the terminal station, based on which the terminal station determines whether to perform a handover.

Moreover, according to still another aspect of the present invention, there is provided a radio communication system comprising a terminal station and a base station. The terminal station includes an uplink quality information collecting unit that transmits, when there is no uplink data transmission from the terminal station for a predetermined time, dummy data to a base station that is currently connected to the terminal station, and collects uplink-quality information that is generated by transmitting the dummy data to the base station and a handover determining unit that determines whether to perform a handover based on the uplink-quality information collected by the uplink quality information collecting unit. The base station includes a downlink quality information collecting unit that transmits, when there is no downlink data transmission for a predetermined time, dummy data to a terminal station that is currently connected to the base station, and collects downlink-quality information that is generated by transmitting the dummy data to the terminal station and an information transmitting unit that transmits the downlink-quality information collected by the downlink quality information collecting unit to the terminal station, based on which the terminal station determines whether to perform a handover.

Furthermore, according to still another aspect of the present invention, there is provided a radio communication system comprising a terminal station and a base station. The terminal station includes an uplink quality information collecting unit that periodically transmits dummy data to a base station that a base station currently connected to the terminal station, and collects uplink-quality information that is generated by transmitting the dummy data to the base station and a handover determining unit that determines whether to perform a handover based on the uplink-quality information collected by the uplink quality information collecting unit. The base station includes a downlink quality information collecting unit that periodically transmits dummy data to a terminal station that is currently connected to the base station, and collects downlink-quality information that is generated by transmitting the dummy data to the terminal station and an information transmitting unit that transmits the downlink-quality information collected by the downlink quality information collecting unit to the terminal station, based on which the terminal station determines whether to perform a handover.

Moreover, according to still another aspect of the present invention, there is provided a radio communication system comprising a terminal station and a base station. The terminal station includes an uplink quality information collecting unit that transmits, when there is no uplink data transmission from the terminal station for a predetermined time, dummy data to a base station that is currently connected to the terminal station, and collects uplink-quality information that is generated by transmitting the dummy data to the base station and a handover determining unit that determines whether to perform a handover based on the uplink-quality information collected by the uplink quality information collecting unit. The base station includes a downlink quality information collecting unit that transmits, when there is no downlink data transmission for a predetermined time, dummy data to a terminal station that is currently connected to the base station, and collects downlink-quality information that is generated by transmitting the dummy data to the terminal station and an information transmitting unit that transmits the downlink-quality information collected by the downlink quality information collecting unit to the terminal station, based on which the terminal station determines whether to perform a handover.

Furthermore, according to still another aspect of the present invention, there is provided a radio communication system comprising a terminal station and a base station. The terminal station includes an uplink quality information collecting unit that periodically transmits dummy data to a base station that a base station currently connected to the terminal station, and collects uplink-quality information that is generated by transmitting the dummy data to the base station and a handover determining unit that determines whether to perform a handover based on the uplink-quality information collected by the uplink quality information collecting unit. The base station includes a downlink quality information collecting unit that periodically transmits dummy data to a terminal station that is currently connected to the base station, and collects downlink-quality information that is generated by transmitting the dummy data to the terminal station and an information transmitting unit that transmits the downlink-quality information collected by the downlink quality information collecting unit to the terminal station, based on which the terminal station determines whether to perform a handover.

Moreover, according to still another aspect of the present invention, there is provided a method of determining whether to perform a handover in a terminal station that makes up a radio communication system with a base station. The method includes monitoring an uplink data transmission from the terminal station to a base station that is currently connected to the terminal station; transmitting, when a result of monitoring at the monitoring indicates that there is no uplink data transmission for a predetermined time, dummy data to the base station; collecting uplink-quality information that is generated by transmitting the dummy data to the base station; and determining whether to perform the handover based on the uplink-quality information collected at the collecting.

Furthermore, according to still another aspect of the present invention, there is provided a method of determining whether to perform a handover in a terminal station that makes up a radio communication system with a base station. The method includes transmitting periodically dummy data to a base station that is currently connected to the terminal station; collecting uplink-quality information that is generated by transmitting the dummy data to the base station; and determining whether to perform the handover based on the downlink-quality information collected at the collecting.

Moreover, according to still another aspect of the present invention, there is provided a method of transmitting downlink-quality information to a terminal station from a base station in a radio communication system. The method includes monitoring a downlink data transmission to a terminal station that is currently connected to the base station; transmitting, when a result of monitoring at the monitoring indicates that there is no downlink data transmission for a predetermined time, dummy data to the terminal station; collecting downlink-quality information that is generated by transmitting the dummy data to the terminal station; and transmitting the downlink-quality information collected at the collecting to the terminal station, based on which the terminal station determines whether to perform a handover.

Furthermore, according to still another aspect of the present invention, there is provided a method of transmitting downlink-quality information to a terminal station from a base station in a radio communication system. The method includes transmitting periodically dummy data to a terminal station that is currently connected to the base station; collecting downlink-quality information that is generated by transmitting the dummy data to the terminal station; and transmitting the downlink-quality information collected at the collecting to the terminal station, based on which the terminal station determines whether to perform a handover.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a terminal station according to a first embodiment of the present invention;

FIG. 2 is an example of a communication control sequence performed by the terminal station and base stations according to the first embodiment;

FIG. 3 is a schematic diagram for explaining unit-based operations of the terminal station shown in FIG. 1;

FIG. 4 is an example of a communication control sequence performed by a terminal station and base stations according to a second embodiment of the present invention;

FIG. 5 is a schematic diagram for explaining unit-based operations of the terminal station according to the second embodiment;

FIG. 6 is a schematic diagram for explaining unit-based operations of a terminal station according to a third embodiment of the present invention;

FIG. 7 is an example of a communication control sequence performed by the terminal station and the base stations according to the fourth embodiment;

FIG. 8 is a block diagram of a base station according to a fifth embodiment of the present invention;

FIG. 9 is an example of a communication control sequence performed by a terminal station and the base stations according to the fifth embodiment;

FIG. 10 is a schematic diagram for explaining unit-based operations of the base station according to the fifth embodiment;

FIG. 11 is an example of a handover-control sequence performed by a terminal station and base stations according to a sixth embodiment of the present invention;

FIG. 12 is a schematic diagram for explaining unit-based operations of the base station according to the sixth embodiment; and

FIG. 13 is an example of a handover-control sequence performed by a terminal station and base stations according to a seventh embodiment of the present invention; and

FIG. 14 is a schematic diagram for explaining unit-based operations of the base station according to the seventh embodiment.

### DETAILED DESCRIPTION OF THE PREFERRED EMBODIMENTS

Exemplary embodiments of the present invention are described in detail below with reference to the accompanying drawings.

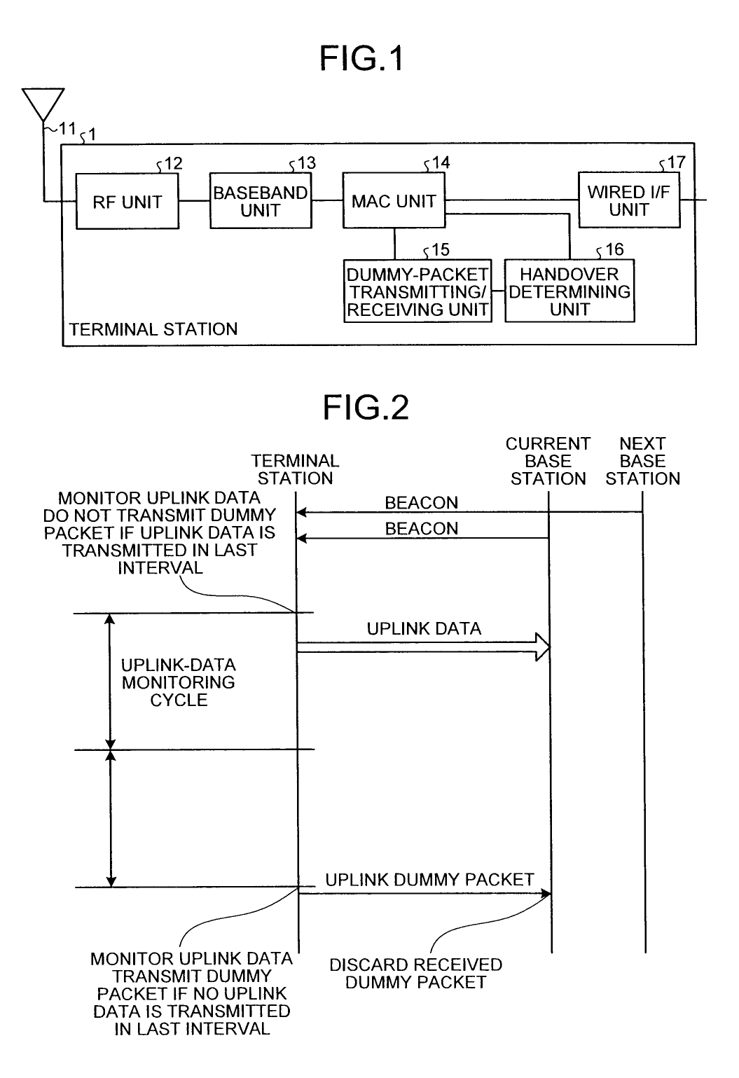

FIG. 1 is a block diagram of a terminal station 1 according to a first embodiment of the present invention. The terminal station 1 includes an antenna 11, a radio frequency (RF) unit 12, a baseband unit 13, a media access control (MAC) unit 14, a dummy-packet transmitting/receiving unit 15, a handover determining unit 16, and a wired interface (I/F) unit 17. The terminal station 1 is connected to one of base stations in a radio communication system. The base station that is currently being connected to the terminal station 1 is called “current base station”. The terminal station 1 has a function of communicating with an external network to which the current base station is connected, and a handover function of switching the current base station to another.

The RF unit 12 converts a frequency of a received signal that is received from an external device via the antenna 11 or an input signal that is received from the baseband unit 13. The baseband unit 13 baseband-processes the received signal that is received from the RF unit 12 and a signal to be transmitted that is received from the MAC unit 14. The MAC unit 14 processes a MAC layer. The dummy-packet transmitting/receiving unit 15 transmits/receives a dummy packet. The handover determining unit 16 determines based on information acquired from the MAC unit 14 or the dummy-packet transmitting/receiving unit 15 whether handover is to be performed. The wired I/F unit 17 is used to connect an external device such as a laptop personal computer to the terminal station 1 so that the external device can transmit/receive data via the terminal station 1. Data received from the base station is called “uplink data”, while data to be transmitted to the base station is called “downlink data”.

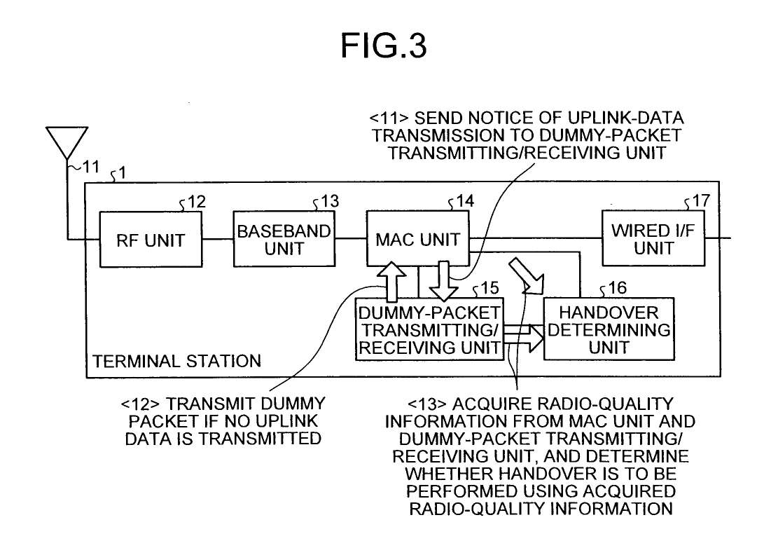

Given below is an explanation about operations in which the terminal station 1 performs handover and switches the current base station to another with reference to FIGS. 2 and 3. FIG. 2 is an example of a communication control sequence performed by the terminal station 1, the current base station, and a next base station. The next base station is to become the current base station after handover. In the example, the terminal station 1 receives a beacon signal both from the current base station and the next base station. FIG. 3 is a schematic diagram for explaining unit-based operations of the terminal station 1. The schematic diagram shown in FIG. 3 is obtained by adding explanations about featured operations to the block diagram shown in FIG. 1.

As shown in FIG. 2, the terminal station 1 periodically receives the beacon signal from both the current base station and the next base station, and acquires from the received beacon signal information about radio quality in a direction from the base station to the terminal station 1 (hereinafter, “downlink radio-quality information”). The downlink radio-quality information includes, for example, an electric-power level of the received beacon signal, and information about a transmission rate extracted from the received beacon signal (i.e., transmission rate supported by the base station from which the beacon signal is transmitted). The MAC unit 14 collects the downlink radio-quality information, and sends the collected downlink radio-quality information to the handover determining unit 16. The handover determining unit 16 uses the downlink radio-quality information to determine whether handover is to be performed. More particularly, for example, the RF unit 12 measures the electric-power level of the received beacon signal, and the MAC unit 14 extracts the transmission rate from the received beacon signal.

The terminal station 1 monitors whether uplink data that is received from the external device via the wired I/F unit 17 is transmitted to the current base station, in addition to processing of the received beacon signal. When a predetermined period has passed since the last transmission of the uplink data, the terminal station 1 transmits dummy data (i.e., uplink dummy packet shown in FIG. 2) to the current base station. Thus, the terminal station 1 collects information about radio quality in a direction from the terminal station 1 to the base station (hereinafter, “uplink radio-quality information”).

Given below are explanations about unit-based operations of the terminal station 1. Upon receiving the uplink data from the wired I/F unit 17, the MAC unit 14 performs required processing to transmit the received uplink data to the base station, and sends to the dummy-packet transmitting/receiving unit 15 a notice that the uplink data has been transmitted (hereinafter, “notice of uplink-data transmission”, see <11> shown in FIG. 3). The dummy-packet transmitting/receiving unit 15 periodically checks whether the notice of uplink-data transmission is received in the last interval. The interval of time the uplink data is monitored is called “uplink-data monitoring cycle”. If the dummy-packet transmitting/receiving unit 15 receives the notice of uplink-data transmission (i.e., uplink data has been transmitted) in the last interval, the dummy-packet transmitting/receiving unit 15 repeats checking. If the dummy-packet transmitting/receiving unit 15 does not receive the notice of uplink-data transmission (i.e., no uplink data is transmitted) in the last interval, the dummy-packet transmitting/receiving unit 15 transmits the dummy packet to the base station (see, <12> shown in FIG. 3), and collects the uplink radio-quality information using the transmitted dummy packet (see, a former half described in <13> shown in FIG. 3). The uplink radio-quality information includes, for example, a transmission rate at which the dummy packet is transmitted and the number of re-transmissions of the dummy packet. If the dummy-packet transmitting/receiving unit 15 receives an acknowledge packet (ACK packet) in response to the dummy packet from the base band, an electric-power level of the received ACK packet is stored as the uplink radio-quality information. The collected uplink radio-quality information is sent to the handover determining unit 16. Any type of packets including data packets, management packets, and administration packets of the wireless LAN can be used as the dummy packet. For example, a data packet in which the type of packet is “data” and the data length is 0 is transmitted as the dummy data.

Upon transmitting the uplink data, the terminal station 1 collects the uplink radio-quality information using the transmitted uplink data in the same manner as collecting the uplink radio-quality information using the transmitted dummy packet. More particularly, the MAC unit 14 collects the uplink radio-quality information, and sends the collected uplink radio-quality information to the handover determining unit 16.

The handover determining unit 16 determines from both the downlink radio-quality information and the uplink radio-quality information whether handover is to be performed (see, a latter half described in <13> shown in FIG. 3). For example, the handover determining unit 16 periodically checks the stored uplink radio-quality information and the stored downlink radio-quality information. The handover determining unit 16 compares the electric-power level of the beacon signal received from the current base station with the electric-power level of the beacon signal received from the next base station, determines whether the number of re-transmissions of the uplink data (or the dummy packet) is larger than a first threshold, and determines whether the transmission rate is higher than a second threshold. The handover determining unit 16 determines whether handover is to be performed from a logical sum that is obtained from a result of comparison between the electric-power levels, a result of determination about the number of re-transmissions, and a result of determination about the transmission rate. Alternatively, the handover determining unit 16 first obtains a result by determining whether the number of re-transmissions of the uplink data is larger than the first threshold and determining whether the transmission rate is higher than the second threshold. The handover determining unit 16 then determines whether handover is to be performed from the above result and the result of comparison between the electric-power levels. The interval of time the handover determining unit 16 checks the downlink radio-quality information and the uplink radio-quality information to determine whether handover is to be performed is called “handover monitoring cycle”. The handover monitoring cycle is set shorter than the uplink-data monitoring cycle shown in FIG. 2.

Alternatively, the handover determining unit 16 determines whether handover is to be performed not periodically but inconstantly in response to occurrence of an event, for example, deterioration of the uplink communication. For example, when it is determined that the transmission rate of the uplink data is lower than a threshold or that the number of re-transmissions of the uplink data is larger than a threshold, the handover determining unit 16 checks the downlink radio-quality information and determines whether handover is to be performed. Still alternatively, the handover determining unit 16 determines whether handover is to be performed in response to occurrence of re-transmission.

Upon determining that handover is to be performed, the handover determining unit 16 sends a command to the RF unit 12 and the baseband unit 13 via the MAC unit 14 to start handover. Upon receiving the command, the RF unit 12, the baseband unit 13, and the MAC unit 14 performs handover, and thus the current base station is switched to the next base station.

The terminal station 1 sets, for example, a predetermined address as the destination address of the dummy packet. If receiving a packet with the predetermined address as the destination address, the base station discards the received packet (i.e., dummy packet) without transmitting the received packet to the destination address.

The base station to which the terminal station can be connected as the next base station (hereinafter, “potential next-base station”) is only one in the above example. If the terminal station receives the beacon signal from a plurality of potential next-base stations, the terminal station collects the downlink radio-quality information separated based on each base station. The terminal station selects, before handover, the next base station from among the potential next-base stations using a plurality of pieces of the downlink radio-quality information. The terminal station selects the next base station in a manner, for example, described in Japanese Patent Application Laid-open No. 2005-323034.

The terminal station of the first embodiment collects the uplink radio-quality information using the transmitted uplink data. Moreover, the terminal station collects the uplink radio-quality information by transmitting the dummy packet if there is no uplink data to be transmitted for a predetermined period. The conventional terminal station determines whether handover is to be performed based on only the downlink radio-quality information that is obtained from the beacon signal. The terminal station of the first embodiment, in contrast, determines whether handover is to be performed based on both the downlink radio-quality information and the uplink radio-quality information. As a result, possibility of wrong handover determination decreases, which implements the effective radio communications.

Given below is an explanation about handover-control operations performed by a terminal station 1a according to a second embodiment of the present invention. As described above, the uplink-data monitoring cycle is independent of the handover monitoring cycle in the first embodiment. In contrast, the uplink-data monitoring cycle is equivalent to the handover monitoring cycle in the second embodiment. The structure of the terminal station 1a is similar to the structure of the terminal station 1 (see, FIG. 1).

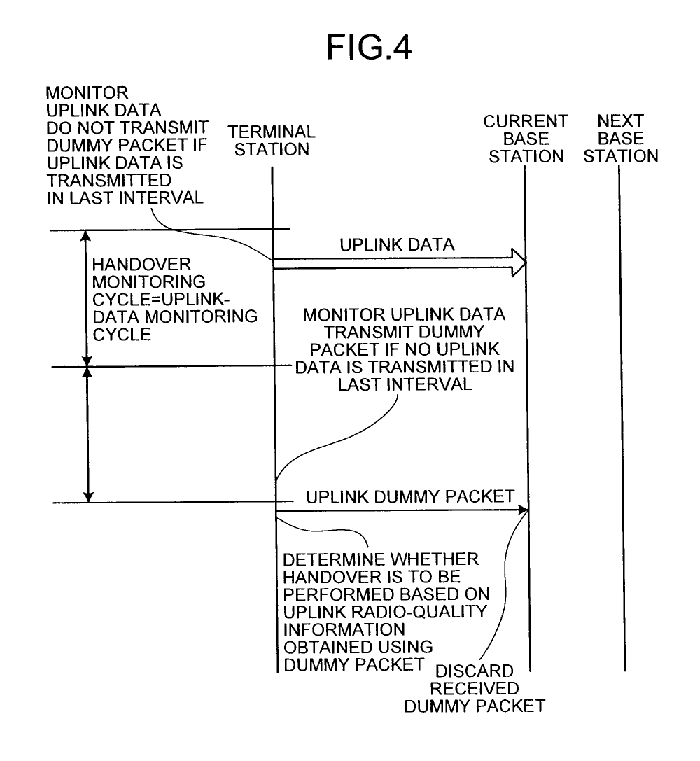

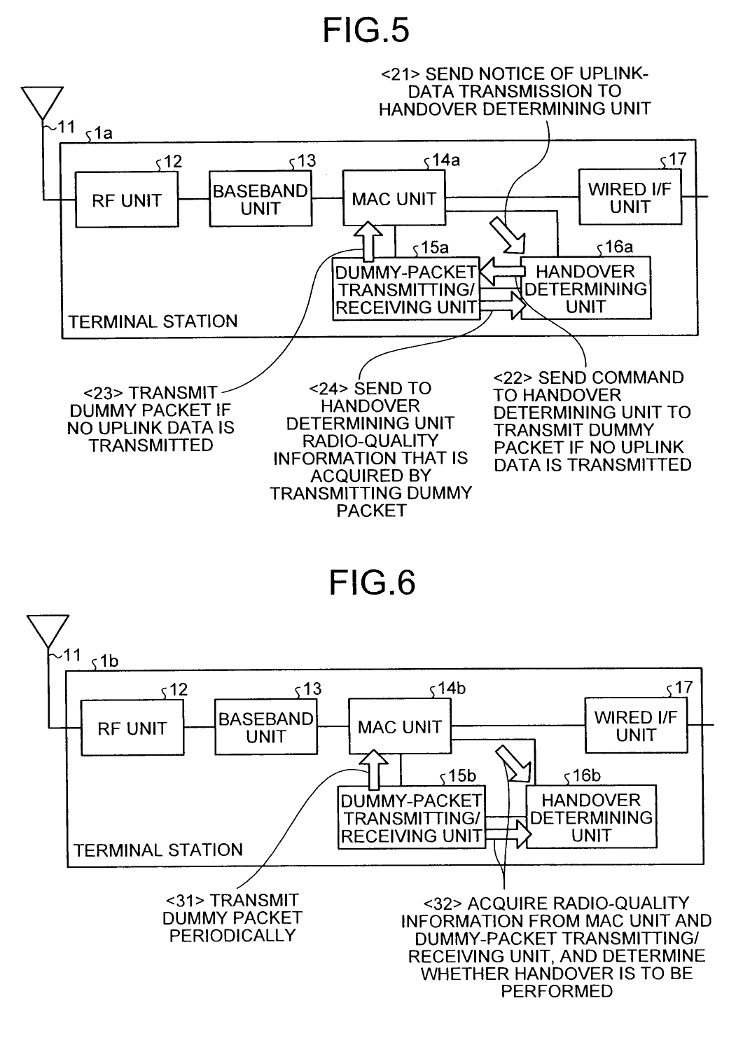

FIG. 4 is an example of a communication control sequence performed by the terminal station 1a, the current base station, and the next base station. In the example, the terminal station 1a receives the beacon signal both from the current base station and the next base station. FIG. 5 is a schematic diagram for explaining unit-based operations of the terminal station 1a. The schematic diagram shown in FIG. 5 is obtained by adding explanations about featured operations to the block diagram shown in FIG. 1. Given below is an explanation in which the terminal station 1a performs handover and switches the current base station to the next base station with reference to FIGS. 4 and 5. Explanations about unit-based operations similar to those in the first embodiment are not repeated.

When the terminal station 1a receives the beacon signal, a MAC unit 14a collects the downlink radio-quality information and a handover determining unit 16a stores therein the collected downlink radio-quality information in the same manner as the terminal station 1 does.

In the terminal station 1a, in contrast to the terminal station 1, the handover determining unit 16a monitors transmission of the uplink data. More particularly, the MAC unit 14a sends the notice of uplink-data transmission to the handover determining unit 16a (see, <21> shown in FIG. 5). When a predetermined period has passed since the last transmission of the uplink data, the handover determining unit 16a sends a command to a dummy-packet transmitting/receiving unit 15a to transmit the dummy packet (see, <22> shown in FIG. 5). Upon receiving the command, the dummy-packet transmitting/receiving unit 15a transmits the dummy packet to the base station, and acquires the uplink radio-quality information using the transmitted dummy packet. The dummy-packet transmitting/receiving unit 15a sends the acquired uplink radio-quality information to the handover determining unit 16a (see, <24> shown in FIG. 5).

The handover determining unit 16a determines whether handover is to be performed by checking the uplink radio-quality information and the downlink radio-quality information stored therein periodically with the handover monitoring cycle shown in FIG. 4, and determines periodically with the same cycle whether the uplink data has been transmitted in the last interval. When the handover determining unit 16a determines that handover is to be performed, the terminal station 1a performs handover. The handover determining unit 16a determines whether handover is to be performed in the same manner as the handover determining unit 16 determines in the first embodiment. When it is determined that the predetermined period has passed since the last transmission of the uplink data, the terminal station 1a transmits the dummy packet to the base station in the same manner as the terminal station 1 transmits in the first embodiment.

If conditions to perform handover and conditions to transmit the dummy packet are satisfied at the same time, the terminal station 1a performs handover without transmitting the dummy packet. More particularly, the handover determining unit 16a first determines whether handover is to be performed. When handover is not to be performed, the handover determining unit 16a then determines whether the uplink data has been transmitted in the last interval. With this configuration, the dummy packet is not transmitted in an unnecessary situation, which makes it possible to perform the various determination processes in an efficient manner.

The terminal station of the second embodiment sets the handover monitoring cycle synchronized with the uplink-data monitoring cycle, and determines whether handover is to be performed before determining whether the dummy packet is to be transmitted. The terminal station determines whether handover is to be performed based on the uplink radio-quality information that is obtained using the transmitted dummy packet or the like and the downlink radio-quality information that is obtained using the received beacon signal. In this manner, it is possible to obtain, while obtaining the same effects as in the first embodiment, the simpler management of the monitoring cycles and the efficient dummy-packet transmission in which no dummy packet is transmitted in the unnecessary situation.

Given below is an explanation about handover-control operations performed by a terminal station 1b according to a third embodiment of the present invention. As described above, the terminal station 1 or 1a monitors transmission of the uplink data, and determines whether the dummy packet is to be transmitted based on the result of monitoring. In contrast, the terminal station 1b periodically transmits the dummy packet with regardless of the result of monitoring. The structure of the terminal station 1b is similar to the structure of the terminal station 1 (see, FIG. 1).

FIG. 6 is a schematic diagram for explaining unit-based operations of the terminal station 1b. The schematic diagram shown in FIG. 6 is obtained by adding explanations about featured operations to the block diagram shown in FIG. 1. Given below is an explanation in which the terminal station 1b performs handover and switches the current base station to the next base station with reference to FIG. 6. Explanations about unit-based operations similar to those in the first embodiment are not repeated.

When the terminal station 1b receives the beacon signal, a MAC unit 14b collects the downlink radio-quality information and a handover determining unit 16b stores therein the collected downlink radio-quality information in the same manner as the terminal station 1 does.

The terminal station 1b, in contrast to the terminal station 1 or 1a, does not monitor transmission of the uplink data. A dummy-packet transmitting/receiving unit 15b acquires the uplink radio-quality information by periodically transmitting the dummy packet with regardless of presence of the uplink data to be transmitted (see, <31> shown in FIG. 6). The dummy-packet transmitting/receiving unit 15b sends the acquired uplink radio-quality information to the handover determining unit 16b (see, <32> shown in FIG. 6).

When transmitting the uplink data, the terminal station 1b collects the uplink radio-quality information using the transmitted uplink data in the same manner when transmitting the dummy packet. More particularly, the MAC unit 14b collects the uplink radio-quality information and sends the collected uplink radio-quality information to the handover determining unit 16b.

The handover determining unit 16b determines whether handover is to be performed based on the uplink radio-quality information and the downlink radio-quality information stored therein. The uplink radio-quality information includes information collected using the uplink data and information collected using the dummy packet. The handover determining unit 16 uses either latest information from among the uplink radio-quality information or all of the uplink radio-quality information.

The handover determining unit 16b can determine whether handover is to be performed at variable timing, i.e., periodically or in response to occurrence of the predetermined event in the same manner as the handover determining unit 16. The same procedure described in the first embodiment is also used in the third embodiment to determine whether handover is to be performed.

The terminal station 1b can stop transmission of the dummy packet when a high load is burdened on the uplink communication. For example, it is detected that the high load is burdened on the uplink communications, the MAC unit 14b stops transmission of the dummy packet.

The terminal station of the third embodiment collects the uplink radio-quality information by periodically transmitting the dummy packet with regardless of transmission of the uplink data. The terminal station determines whether handover is to be performed based on the uplink radio-quality information that is obtained using the dummy packet and the downlink radio-quality information that is obtained using the received beacon signal. In this manner, it is possible to obtain, while obtaining the same effects as in the first embodiment, the simpler control procedure excluding the uplink-data monitoring.

Given below is an explanation about handover-control operations performed by a terminal station 1c according to a fourth embodiment of the present invention. As described above, the terminal station 1, 1a, or 1b transmits the dummy packet to the current base station only. In contrast, the terminal station 1c transmits the dummy packet to both the current base station and the next base station. The structure of the terminal station 1c is similar to the structure of the terminal station 1 (see, FIG. 1).

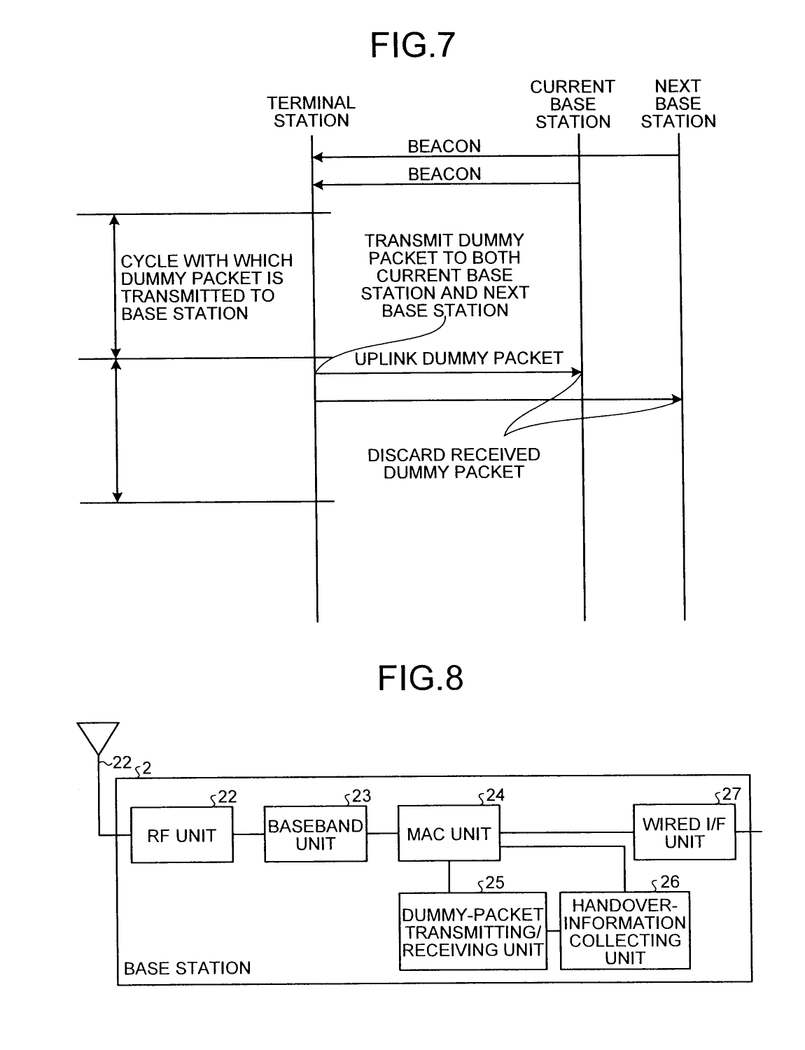

FIG. 7 is an example of a communication control sequence performed by the terminal station 1c, the current base station, and the next base station. In the example, the terminal station 1c receives the beacon signal both from the current base station and the next base station. Given below is an explanation in which the terminal station 1c performs handover and switches the current base station to the next base station with reference to FIG. 7. Explanations about operations similar to those in the first embodiment are not repeated.

When the terminal station 1c receives the beacon signal, a MAC unit 14c collects the downlink radio-quality information and a handover determining unit 16c stores therein the collected downlink radio-quality information in the same manner as the terminal station 1 does.

The terminal station 1c monitors transmission of the uplink data. When a predetermined period has passed since the last transmission of the uplink data, the terminal station 1c transmits the dummy packet to both the current base station and the next base station, and collects uplink radio-quality information between the terminal station 1c and the current base station and uplink radio-quality information between the terminal station 1c and the next base station. The potential next-base station is only one in the example shown in FIG. 7. If there is a plurality of potential next-base stations, the terminal station 1c transmits the dummy packet to each of the potential next-base stations.

The terminal station 1c determines whether handover is to be performed based on the collected uplink radio-quality information and the collected downlink radio-quality information in the same manner as the terminal station 1 determines. If there is a plurality of potential next-base stations, the terminal station 1c selects the next base station from among the potential next-base stations using the uplink radio-quality information and the downlink radio-quality information about each of the potential next-base stations. The terminal station 1c selects the next base station, for example, in the manner described in Japanese Patent Application Laid-open No. 2005-323034 by comparing the potential next-base stations in the electric-power level of the received beacon signal, the uplink transmission rate at receiving the beacon signal, the electric-power level of the received ACK packet in response to the transmitted dummy packet, the number of re-transmissions of the dummy packet, and the transmission rate at transmitting the dummy packet.

The terminal station of the fourth embodiment collects the uplink radio-quality information by transmitting the dummy packet to the current base station and the next base stations when a predetermined period has passed since the last transmission of the uplink data. The terminal station determines whether handover is to be performed based on the uplink radio-quality information and the downlink radio-quality information. If there is a plurality of potential next-base stations, the terminal station selects the next base station from among the potential next-base stations based on the uplink radio-quality information and the downlink radio-quality information about each of the potential next-base stations. With this configuration, it is possible to decrease the possibility of wrong handover determination, and to select the best one as the next base station from among the potential next-base stations.

Moreover, the terminal station 1c having the same functions of the terminal station 1 collects the uplink radio-quality information about each of the potential next-base stations by transmitting the dummy packet to the potential next-base stations. In other words, the terminal station 1c is obtained by adding the featured function (i.e., function of acquiring the uplink radio-quality information by transmitting the dummy packet to the potential next-base stations) to the terminal station 1. Another terminal station can be obtained by adding the featured function to the terminal station 1a or 1b.

Given below is an explanation about handover-control operations according to a fifth embodiment of the present invention. As described above, the terminal station according to any one of the first embodiment to the fourth embodiments collects the uplink radio-quality information by transmitting the dummy packet to the base station. The terminal station determines whether handover is to be performed based on the collected uplink radio-quality information. In contrast, a base station of the fifth embodiment collects downlink transmission-quality information by transmitting a dummy packet to the terminal station. The base station transmits the collected downlink transmission-quality information to the terminal station. The terminal station determines whether handover is to be performed based on the received downlink transmission-quality information.

FIG. 8 is a block diagram of a base station 2 according to the fifth embodiment. The base station 2 includes an antenna 21, an RF unit 22, a baseband unit 23, a MAC unit 24, a dummy-packet transmitting/receiving unit 25, a handover-information collecting unit 26, and a wired I/F unit 27.

The RF unit 22 converts a frequency of a received signal that is received from an external device via the antenna 21 or an input signal that is received from the baseband unit 23. The baseband unit 23 baseband-processes the received signal that is received from the RF unit 22 and a signal to be transmitted that is received from the MAC unit 24. The MAC unit 24 processes a MAC layer. The dummy-packet transmitting/receiving unit 25 transmits/receives the dummy packet. The handover-information collecting unit 26 collects from the MAC unit 24 and the dummy-packet transmitting/receiving unit 25 the handover information that is used by the terminal station to determine whether handover is to be performed. The wired I/F unit 27 is used to connect the base station 2 with an external network such as a wireless LAN.

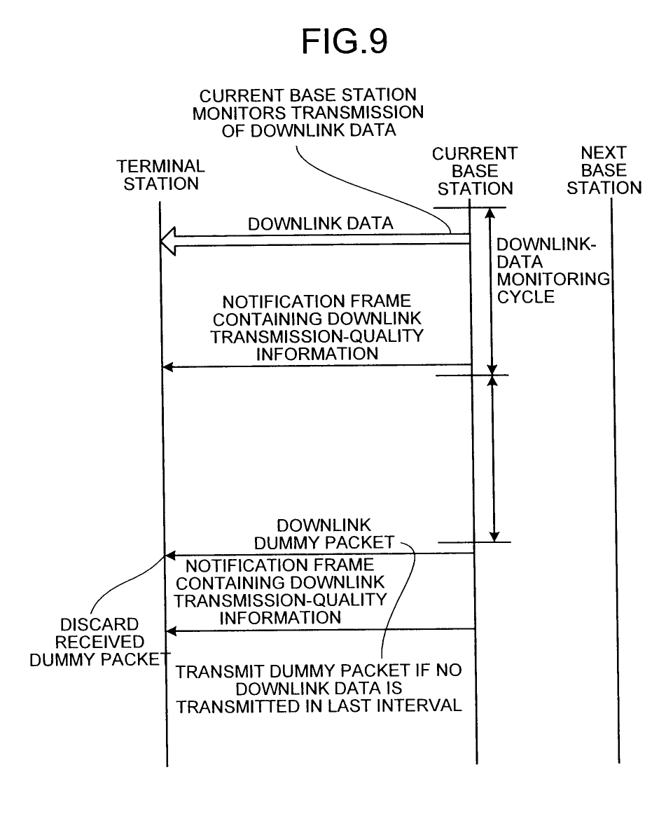

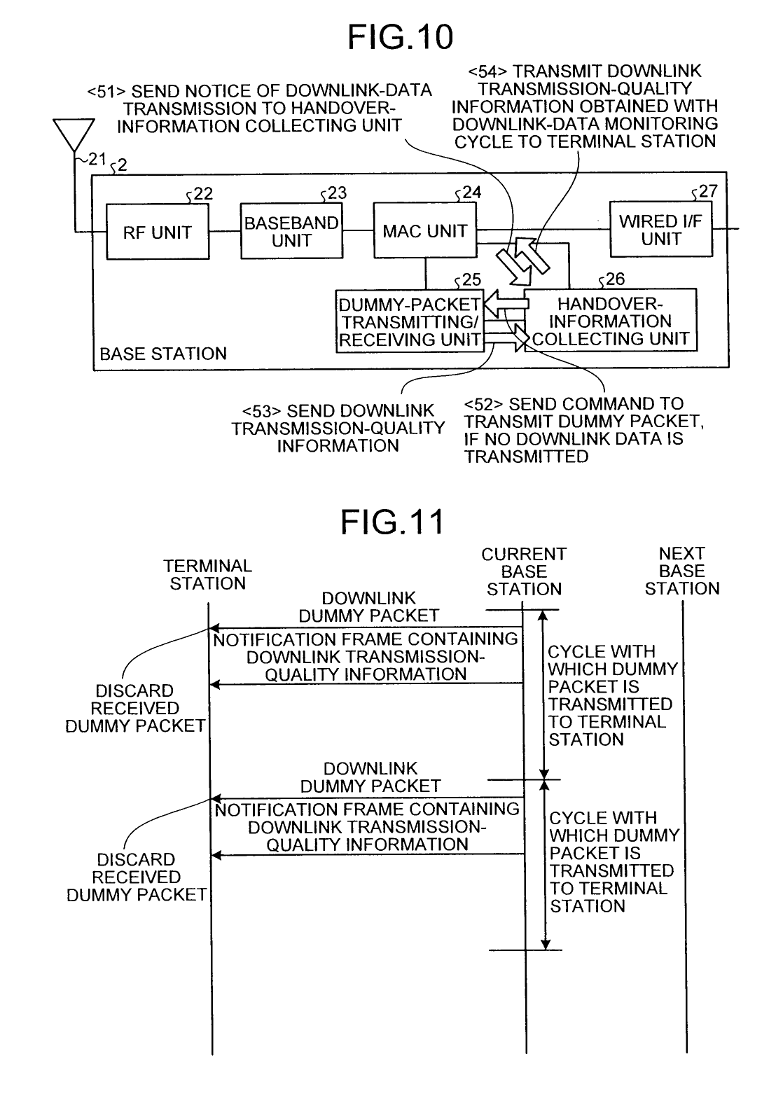

Given below is an explanation about handover-control operations performed by the base station 2 with reference to FIGS. 9 and 10. FIG. 9 is an example of a communication control sequence performed by the terminal station and the base stations 2. In the example, the terminal station receives the beacon signal both from the current base station and the next base station. FIG. 10 is a schematic diagram for explaining unit-based operations of the base station 2. The schematic diagram shown in FIG. 10 is obtained by adding explanations about featured operations to the block diagram shown in FIG. 8.

The base station 2 is connected to a terminal station 1d that is obtained by adding a featured function of determining whether handover is to be performed using transmission-quality information received from the base station 2 to the terminal station 1, 1a, 1b, or 1c.

As shown in FIG. 9, the base station 2 monitors transmission of downlink data to the terminal station 1d. The downlink data is received from the external network via the wired I/F unit 27. When a predetermined period has passed since the last transmission of the downlink data, the base station 2 transmits dummy data (i.e., downlink dummy packet shown in FIG. 9) to the terminal station id that is currently being connected to the base station 2. The base station 2 collects information about data transmission quality in a direction from the base station 2 to the terminal station 1d (hereinafter, “downlink transmission-quality information”). The base station 2 transmits a notification frame containing the collected downlink transmission-quality information to the terminal station 1d.

Given below are explanations about unit-based operations of the base station 2. When the MAC unit 24 receives the downlink data from the wired I/F unit 27, the MAC unit 24 performs required processing to transmit the received downlink data to the terminal station 1d, and sends to the handover-information collecting unit 26 a notice that the downlink data has been transmitted (hereinafter, “notice of downlink-data transmission”, see <51> shown in FIG. 10). The handover-information collecting unit 26 periodically checks whether the notice of downlink-data transmission is received in the last interval. The interval of time the downlink data is monitored is called “downlink-data monitoring cycle”. If the handover-information collecting unit 26 receives the notice of downlink-data transmission (i.e., downlink data is transmitted) in the last interval, the handover-information collecting unit 26 repeats checking. If the handover-information collecting unit 26 does not receive the notice of downlink-data transmission in the last interval, the handover-information collecting unit 26 sends a command to the dummy-packet transmitting/receiving unit 25 to transmit the dummy packet to the terminal station 1d (see, <52> shown in FIG. 10). Upon receiving the command, the dummy-packet transmitting/receiving unit 25 collects the downlink transmission-quality information by transmitting the dummy packet to the terminal station 1d. The downlink transmission-quality information includes, for example, a transmission rate at which the dummy packet is transmitted and the number of re-transmissions of the dummy packet. It is possible to include in the downlink transmission-quality information an electric-power level of an ACK packet received in response to the transmitted dummy packet. Although any type of packets can be used as the dummy packet, the dummy packet is transmitted at the lowest rate from among selectable rates. This is because a lower rate is more likely to be received by the terminal station 1d in a normal manner than any higher rates are. The dummy-packet transmitting/receiving unit 25 sends the collected downlink transmission-quality information to the handover-information collecting unit 26 (see, <53> shown in FIG. 10).

Upon transmitting the downlink data, the base station 2 collects the downlink transmission-quality information using the transmitted downlink data in the same manner as collecting the downlink transmission-quality information using the transmitted dummy packet. More particularly, the MAC unit 24 collects the downlink transmission-quality information, and sends the collected downlink transmission-quality information to the handover-information collecting unit 26.

As shown in FIG. 9, the base station 2 transmits the notification frame containing the downlink transmission-quality information that is collected using either the transmitted dummy packet or the transmitted downlink data to the terminal station 1d (see, <54> shown in FIG. 10). In other words, as a result of the process performed the handover-information collecting unit 26 as an information notifying unit, the downlink transmission-quality information is transmitted from the base station 2 to the terminal station 1d via the MAC unit 24. The MAC unit 24 can transmit the downlink transmission-quality information either periodically or immediately after reception of the downlink transmission-quality information. If the downlink transmission-quality information is transmitted periodically, the cycle with which downlink transmission-quality information is transmitted is set equivalent to, for example, the downlink-data monitoring cycle.

Upon receiving the downlink transmission-quality information from the base station 2, the terminal station 1d stores therein the received downlink transmission-quality information. The terminal station 1d collects the uplink radio-quality information and the downlink radio-quality information in the same manner as any one of the terminal stations 1, 1a, 1b, and 1c collects. The terminal station 1d determines whether handover is to be performed using the downlink transmission-quality information received from the base station 2, the uplink radio-quality information, and the downlink radio-quality information. The terminal station 1d determines whether handover is to be performed by using the same criteria that any one of the terminal stations 1, 1a, 1b, and 1c uses.

The base station 2 sets, for example, a predetermined address as the destination address of the dummy packet if receiving a packet with the predetermined address as the destination address, the terminal station 1d discards the received packet (i.e., dummy packet) without transmitting the received packet to the destination address.

The base station of the fifth embodiment collects the downlink transmission-quality information using the transmitted downlink data. Moreover, the base station collects the downlink transmission-quality information by transmitting the dummy packet if there is no downlink data to be transmitted for a predetermined period. The base station transmits the collected downlink transmission-quality information to the terminal station as information that is used to determine whether handover is to be performed. As a result, the possibility of wrong handover determination decreases.

The terminal station of the fifth embodiment determines whether handover is to be performed using the downlink transmission-quality information that is received from the base station, and the uplink radio-quality information and the downlink radio-quality information that the terminal station collects by itself using control described in any one of the first embodiment to the fourth embodiment. As a result, the terminal station obtains the possibility of wrong handover determination lower than the possibility that any one of the terminal stations of the first embodiment to the fourth embodiment obtains.

Given below is an explanation about handover-control operations performed by a base station 2a according to a sixth embodiment of the present invention. As described above, the base station 2 of the fifth embodiment monitors transmission of the downlink data, and transmits the dummy packet based on the result of monitoring. In contrast, the base station 2a transmits the dummy packet periodically with regardless of the result of monitoring. The structure of the base station 2a is similar to the structure of the base station 2 (see, FIG. 8). The terminal station 1d is used as a terminal station of the sixth embodiment.

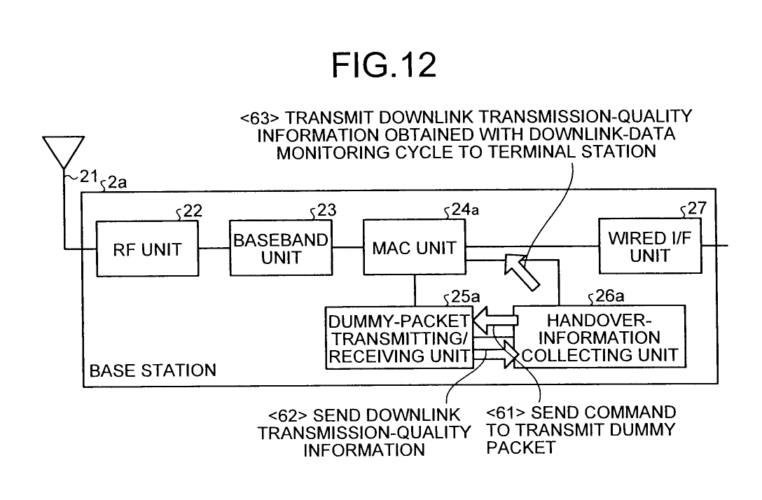

FIG. 11 is an example of a handover-control sequence performed by the terminal station 1d and the base stations 2a. In the example, the terminal station 1d receives the beacon signal both from the current base station and the next base station. FIG. 12 is a schematic diagram for explaining unit-based operations of the base station 2a. The schematic diagram shown in FIG. 12 is obtained by adding explanations about featured operations to the block diagram shown in FIG. 8. Given below is an explanation about handover-control operations performed by the base station 2a with reference to FIGS. 11 and 12. Explanations about control operations similar to those described in the fifth embodiment are not repeated.

As shown in FIG. 11, a handover-information collecting unit 26a, in contrast to the handover-information collecting unit 26, periodically sends the command to a dummy-packet transmitting/receiving unit 25a with regardless of presence of the downlink data to be transmitted (see, <61> shown in FIG. 12). Upon receiving the command, the dummy-packet transmitting/receiving unit 25a transmits the dummy packet to the terminal station 1d, acquires the downlink transmission-quality information using the transmitted dummy packet, and sends the acquired downlink transmission-quality information to the handover-information collecting unit 26a (see, <62> shown in FIG. 12). Upon receiving the downlink transmission-quality information, the handover-information collecting unit 26 transmits the notification frame containing the received downlink transmission-quality information to the terminal station 1d (see, <63> shown in FIG. 12).

As described in the explanation about the fifth embodiment, the terminal station 1d determines whether handover is to be performed based on the uplink radio-quality information, the downlink radio-quality information, and the downlink transmission-quality information.

In this manner, the base station according to the sixth embodiment collects the downlink transmission-quality information by periodically transmitting the dummy packet with regardless of transmission of the downlink data, and transmits the collected downlink transmission-quality information to the terminal station. With this configuration, it is possible to obtain, while obtaining the same effects as in the fifth embodiment, the simpler control procedure excluding the uplink-data monitoring.

Given below is an explanation about handover-control operations performed by a base station 2b according to a seventh embodiment of the present invention. The base station 2 or 2a transmits the dummy packet to the terminal station only when the base station 2 or 2a is currently being connected to the terminal station, i.e., the base station 2 or 2a is working as the current base station. In contrast, the base station 2b transmits the dummy packet to the terminal station even when the base station 2b is working as the next base station of the terminal station. The structure of the base station 2b is similar to the structure of the base station 2 (see, FIG. 8). The terminal station 1d is used as a terminal station of the seventh embodiment.

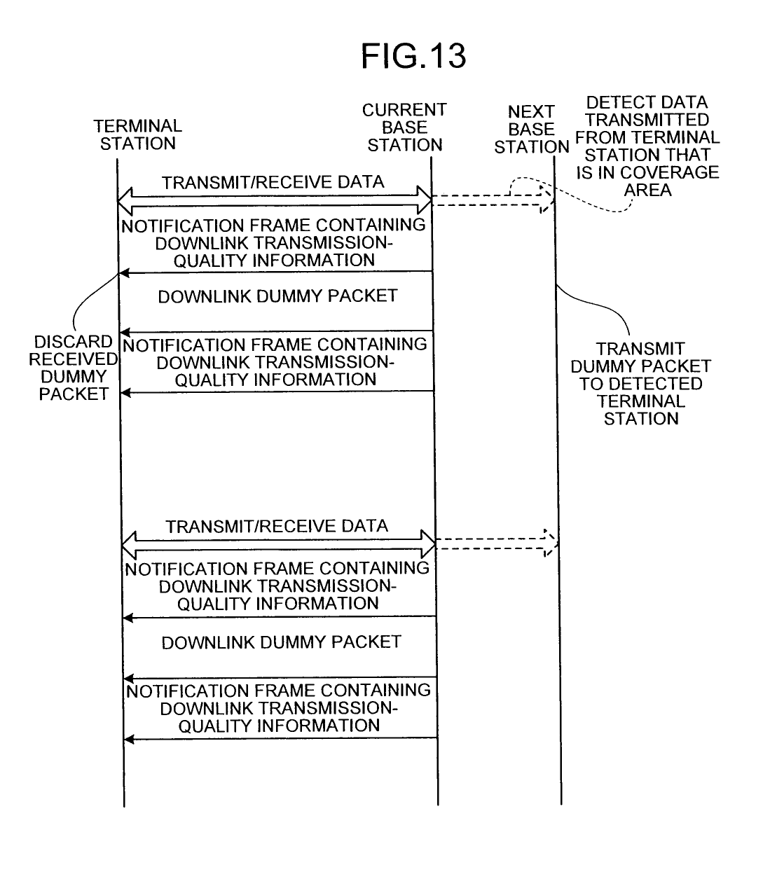

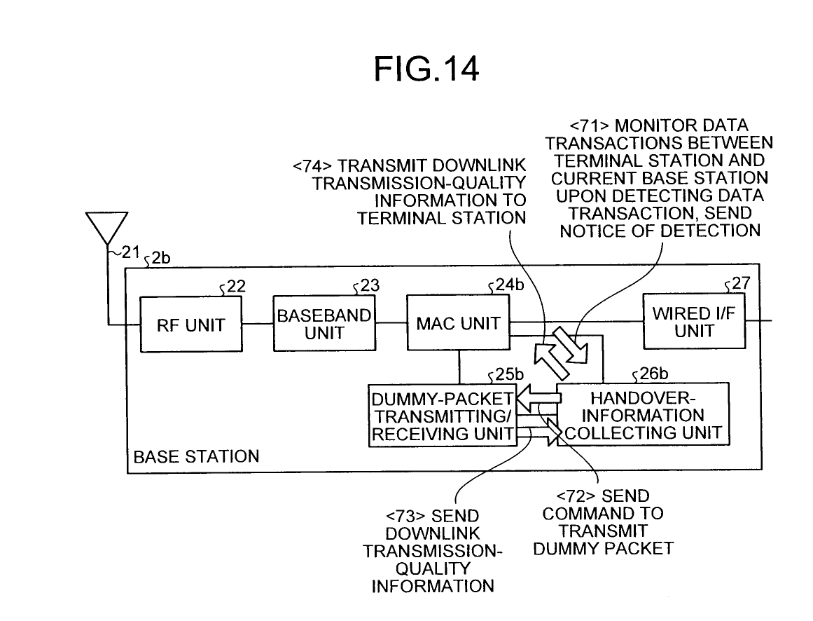

FIG. 13 is an example of a communication control sequence performed by the terminal station 1d and the base station 2b. In the example, the terminal station 1d receives the beacon signal both from the current base and the next base station. FIG. 14 is a schematic diagram for explaining unit-based operations of the base station 2b. The schematic diagram shown in FIG. 14 is obtained by adding explanations about featured operations to the block diagram shown in FIG. 8. Given below is an explanation about handover-control operations performed by the base station 2b with reference to FIGS. 13 and 14. Explanations about control operations similar to those described in the fifth embodiment are not repeated.

As shown in FIG. 13, one of the base stations 2b working as the current base station (hereinafter, “base station 2b-1”) collects the downlink transmission-quality information in the same manner as the base station 2 or 2a collects. The base station 2b-1 transmits the collected downlink transmission-quality information to the terminal station 1d.

Another one of the base stations 2b working as the next base station (hereinafter, “base station 2b-2”) monitors data transactions between the base station 2b-1 and the terminal station 1d, i.e., monitors whether the base station 2b-1 transmits/receives data (including the dummy packet) to/from the terminal station 1d. Upon detecting a data transaction, i.e., when the base station 2b-1 collects the downlink transmission-quality information, the base station 2b-2 transmits the dummy packet to the terminal station 1d and collects using the transmitted dummy packet the downlink transmission-quality information between the terminal station 1d and itself.

Given below are explanations about unit-based operations of the base station 2b-2. A MAC unit 24b monitors data transactions between the base station 2b-1 and the terminal station 1d. Upon detecting the data transaction, the MAC unit 24b sends a notice of detection to a handover-information collecting unit 26b (see, <71> shown in FIG. 14. Upon receiving the notice of detection, the handover-information collecting unit 26b sends the command to a dummy-packet transmitting/receiving unit 25b to transmit the dummy packet to the terminal station 1d (see, <72> shown in FIG. 14). Upon receiving the command, the dummy-packet transmitting/receiving unit 25b transmits the dummy packet to the terminal station 1d, and collects the downlink transmission-quality information between the terminal station 1d and itself. The dummy-packet transmitting/receiving unit 25b sends the collected downlink transmission-quality information to the handover-information collecting unit 26b (see, <73> shown in FIG. 14). Upon receiving the downlink transmission-quality information from the dummy-packet transmitting/receiving unit 25b, the handover-information collecting unit 26b transmits the notification frame containing the received downlink transmission-quality information to the terminal station 1d (see, <74> shown in FIG. 14).

The terminal station 1d determines whether handover is to be performed using the uplink radio-quality information and the downlink radio-quality information that the terminal station 1d collects itself, the downlink transmission-quality information that is received from the base station 2b-1, and the downlink transmission-quality information that is received from the base station 2b-2. For example, the terminal station 1d extracts an electric-power level at which the base station receives the ACK packet from the terminal station id in response to the dummy packet that is transmitted from the base station to the terminal station 1d (hereinafter, “uplink packet electric-power level”) from each of the downlink transmission-quality information received from the base station 2b-1 and the downlink transmission-quality information received from the base station 2b-2. If the uplink packet electric-power level at the base station 2b-2 is higher than the uplink packet electric-power level at the base station 2b-1, the terminal station 1d determines that handover is to be performed. The terminal station 1d can set an offset. More particularly, assuming that the offset is α, the terminal station 1d determines that handover is to be performed when the uplink packet electric-power level at the base station 2b-2 is larger than a sum of the uplink packet electric-power level at the base station 2b-1 and α.

In this manner, if the terminal station is in a coverage area of the base station, the base station of the seventh embodiment collects the downlink transmission-quality information between the terminal station and itself with regardless of whether the terminal station is being connected to the base station currently. In other words, even if the base station is a possible next-base station, the base station collects the downlink transmission-quality information. The base station then transmits the collected downlink transmission-quality information to the terminal station. As a result, the terminal station obtains lower possibility of wrong handover determination.

As described above, according to an aspect of the present invention, it is possible to obtain lower possibility that handover is performed in an unnecessary situation, which implements the effective radio communications.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal station that makes up a radio communication system with a base station, the terminal station comprising:
an uplink quality information collecting unit that transmits, when there is no uplink data transmission from the terminal station for a predetermined time, dummy data to a base station that is currently connected to the terminal station, and collects uplink-quality information that is generated by transmitting the dummy data to the base station; and
a handover determining unit that determines whether to perform a handover based on the uplink-quality information collected by the uplink quality information collecting unit.

2. The terminal station according to claim 1, wherein
the handover determining unit determines whether to perform the handover periodically with a predetermined cycle, and
the uplink quality information collecting unit transmits the dummy data to the base station when there is no uplink data transmission to the base station in the predetermined cycle.

3. The terminal station according to claim 2, wherein, the uplink quality information collecting unit transmits the dummy data to the base station when the handover determining unit determines not to perform the handover and there is no uplink data transmission to the base station in the predetermined cycle.

4. The terminal station according to claim 1, wherein
the uplink quality information collecting unit further transmits the dummy data to a second base station that is a base station located in a range capable of receiving the dummy data from the terminal station, in addition to a first base station that is the base station currently connected to the terminal station, and collects uplink-quality information that is generated by transmitting the dummy data to the first base station and the second base station.

5. The terminal station according to claim 1, wherein the uplink-quality information includes number of re-transmissions of the dummy data, an electric-power level of an acknowledge signal that is received in response to the dummy data, and a transmission rate at which the dummy data is transmitted.

6. A terminal station that makes up a radio communication system with a plurality of base stations, the terminal station comprising:
an uplink quality information collecting unit that periodically transmits dummy data to a base station that a base station currently connected to the terminal station, and collects uplink-quality information that is generated by transmitting the dummy data to the base station; and
a handover determining unit that determines whether to perform a handover based on the uplink-quality information collected by the uplink quality information collecting unit.

7. The terminal station according to claim 6, wherein
the uplink quality information collecting unit further transmits the dummy data to a second base station that is a base station located in a range capable of receiving the dummy data from the terminal station, in addition to a first base station that is the base station currently connected to the terminal station, and collects uplink-quality information that is generated by transmitting the dummy data to the first base station and the second base station.

8. The terminal station according to claim 6, wherein the uplink-quality information includes number of re-transmissions of the dummy data, an electric-power level of an acknowledge signal that is received in response to the dummy data, and a transmission rate at which the dummy data is transmitted.

9. A base station that makes up a radio communication system with a terminal station, the base station comprising:
a downlink quality information collecting unit that transmits, when there is no downlink data transmission for a predetermined time, dummy data to a terminal station that is currently connected to the base station, and collects downlink-quality information that is generated by transmitting the dummy data to the terminal station; and
an information transmitting unit that transmits the downlink-quality information collected by the downlink quality information collecting unit to the terminal station, based on which the terminal station determines whether to perform a handover.

10. The base station according to claim 9, further comprising an area monitoring unit that monitors a data transaction between a second base station and a second terminal station that is a terminal station in a range capable of receiving a signal from the base station and currently connected to the second base station, wherein
when the area monitoring unit detects that there is no data transaction between the second base station and the second terminal station, the downlink quality information collecting unit transmits the dummy data to the second terminal station, and collects downlink-quality information that is generated by transmitting the dummy data to the second terminal station, and
when the downlink quality information collecting unit collects the downlink-quality information that is generated by transmitting the dummy data to the second terminal station, the information transmitting unit transmits the downlink-quality information collected by the downlink quality information collecting unit to the second terminal station, with which the second terminal station determines whether to perform the handover.

11. The base station according to claim 9, wherein the downlink-quality information includes number of re-transmissions of the dummy data, an electric-power level of an acknowledge signal that is received in response to the dummy data, and a transmission rate at which the dummy data is transmitted.

12. A base station that makes up a radio communication system with a terminal station, the base station comprising:
a downlink quality information collecting unit that periodically transmits dummy data to a terminal station that is currently connected to the base station, and collects downlink-quality information that is generated by transmitting the dummy data to the terminal station; and
an information transmitting unit that transmits the downlink-quality information collected by the downlink quality information collecting unit to the terminal station, based on which the terminal station determines whether to perform a handover.

13. The base station according to claim 12, further comprising an area monitoring unit that monitors a data transaction between a second base station and a second terminal station that is a terminal station in a range capable of receiving a signal from the base station and currently connected to the second base station, wherein
when the area monitoring unit detects that there is no data transaction between the second base station and the second terminal station, the downlink quality information collecting unit transmits the dummy data to the second terminal station, and collects downlink-quality information that is generated by transmitting the dummy data to the second terminal station, and
when the downlink quality information collecting unit collects the downlink-quality information that is generated by transmitting the dummy data to the second terminal station, the information transmitting unit transmits the downlink-quality information collected by the downlink quality information collecting unit to the second terminal station, with which the second terminal station determines whether to perform the handover.

14. The base station according to claim 12, wherein the downlink-quality information includes number of re-transmissions of the dummy data, an electric-power level of an acknowledge signal that is received in response to the dummy data, and a transmission rate at which the dummy data is transmitted.

15. A radio communication system comprising a terminal station and a base station, wherein
the terminal station includes
an uplink quality information collecting unit that transmits, when there is no uplink data transmission from the terminal station for a predetermined time, dummy data to a base station that is currently connected to the terminal station, and collects uplink-quality information that is generated by transmitting the dummy data to the base station, and
a handover determining unit that determines whether to perform a handover based on the uplink-quality information collected by the uplink quality information collecting unit, and
the base station includes
a downlink quality information collecting unit that transmits, when there is no downlink data transmission for a predetermined time, dummy data to a terminal station that is currently connected to the base station, and collects downlink-quality information that is generated by transmitting the dummy data to the terminal station, and
an information transmitting unit that transmits the downlink-quality information collected by the downlink quality information collecting unit to the terminal station, based on which the terminal station determines whether to perform a handover.

16. A radio communication system comprising a terminal station and a base station, wherein
the terminal station includes
an uplink quality information collecting unit that periodically transmits dummy data to a base station that a base station currently connected to the terminal station, and collects uplink-quality information that is generated by transmitting the dummy data to the base station, and
a handover determining unit that determines whether to perform a handover based on the uplink-quality information collected by the uplink quality information collecting unit, and
the base station includes
a downlink quality information collecting unit that periodically transmits dummy data to a terminal station that is currently connected to the base station, and collects downlink-quality information that is generated by transmitting the dummy data to the terminal station, and
an information transmitting unit that transmits the downlink-quality information collected by the downlink quality information collecting unit to the terminal station, based on which the terminal station determines whether to perform a handover.

17. A radio communication system comprising a terminal station and a base station, wherein
the terminal station includes
an uplink quality information collecting unit that transmits, when there is no uplink data transmission from the terminal station for a predetermined time, dummy data to a base station that is currently connected to the terminal station, and collects uplink-quality information that is generated by transmitting the dummy data to the base station, and
a handover determining unit that determines whether to perform a handover based on the uplink-quality information collected by the uplink quality information collecting unit, and
the base station includes
a downlink quality information collecting unit that transmits, when there is no downlink data transmission for a predetermined time, dummy data to a terminal station that is currently connected to the base station, and collects downlink-quality information that is generated by transmitting the dummy data to the terminal station, and
an information transmitting unit that transmits the downlink-quality information collected by the downlink quality information collecting unit to the terminal station, based on which the terminal station determines whether to perform a handover.

18. A radio communication system comprising a terminal station and a base station, wherein
the terminal station includes
an uplink quality information collecting unit that periodically transmits dummy data to a base station that a base station currently connected to the terminal station, and collects uplink-quality information that is generated by transmitting the dummy data to the base station, and
a handover determining unit that determines whether to perform a handover based on the uplink-quality information collected by the uplink quality information collecting unit, and
the base station includes
a downlink quality information collecting unit that periodically transmits dummy data to a terminal station that is currently connected to the base station, and collects downlink-quality information that is generated by transmitting the dummy data to the terminal station, and
an information transmitting unit that transmits the downlink-quality information collected by the downlink quality information collecting unit to the terminal station, based on which the terminal station determines whether to perform a handover.

19. A method of determining whether to perform a handover in a terminal station that makes up a radio communication system with a base station, the method comprising:
monitoring an uplink data transmission from the terminal station to a base station that is currently connected to the terminal station;
transmitting, when a result of monitoring at the monitoring indicates that there is no uplink data transmission for a predetermined time, dummy data to the base station;
collecting uplink-quality information that is generated by transmitting the dummy data to the base station; and
determining whether to perform the handover based on the uplink-quality information collected at the collecting.

20. The method according to claim 19, wherein
the monitoring includes monitoring the uplink data transmission from the terminal station to the base station periodically with a predetermined cycle, and
the determining includes determining whether to perform the handover based on the uplink-quality information collected at the collecting periodically with the predetermined cycle.

21. The method according to claim 19, wherein the transmitting includes transmitting the dummy data to the base station when it is determined not to perform the handover at the determining and there is no uplink data transmission to the base station in the predetermined cycle.

22. The method according to claim 19, wherein
the transmitting includes transmitting the dummy data to a second base station that is a base station located in a range capable of receiving the dummy data from the terminal station, in addition to a first base station that is the base station currently connected to the terminal station,
the collecting includes collecting uplink-quality information that is generated by transmitting the dummy data to the first base station and the second base station.

23. The method according to claim 19, wherein the uplink-quality information includes number of re-transmissions of the dummy data, an electric-power level of an acknowledge signal that is received in response to the dummy data, and a transmission rate at which the dummy data is transmitted.

24. A method of determining whether to perform a handover in a terminal station that makes up a radio communication system with a base station, the method comprising:
transmitting periodically dummy data to a base station that is currently connected to the terminal station;
collecting uplink-quality information that is generated by transmitting the dummy data to the base station; and
determining whether to perform the handover based on the downlink-quality information collected at the collecting.

25. The method according to claim 24, wherein
the transmitting includes transmitting the dummy data to a second base station that is a base station located in a range capable of receiving the dummy data from the terminal station, in addition to a first base station that is the base station currently connected to the terminal station,
the collecting includes collecting uplink-quality information that is generated by transmitting the dummy data to the first base station and the second base station.

26. The method according to claim 24, wherein the uplink-quality information includes number of re-transmissions of the dummy data, an electric-power level of an acknowledge signal that is received in response to the dummy data, and a transmission rate at which the dummy data is transmitted.

27. A method of transmitting downlink-quality information to a terminal station from a base station in a radio communication system, the method comprising:
monitoring a downlink data transmission to a terminal station that is currently connected to the base station;
transmitting, when a result of monitoring at the monitoring indicates that there is no downlink data transmission for a predetermined time, dummy data to the terminal station;
collecting downlink-quality information that is generated by transmitting the dummy data to the terminal station; and
transmitting the downlink-quality information collected at the collecting to the terminal station, based on which the terminal station determines whether to perform a handover.

28. The method according to claim 27, further comprising area monitoring including monitoring a data transaction between a second base station and a second terminal station that is a terminal station in a range capable of receiving a signal from the base station and currently connected to the second base station, wherein
the transmitting includes transmitting, when a data transaction between the second base station and the second terminal station is detected at the area monitoring, the dummy data to the second terminal station,
the collecting includes collecting downlink-quality information that is generated by transmitting the dummy data to the second terminal station, and
the transmitting includes transmitting the downlink-quality information collected at the collecting to the second terminal station, with which the second terminal station determines whether to perform the handover.

29. The method according to claim 27, wherein the downlink-quality information includes number of re-transmissions of the dummy data, an electric-power level of an acknowledge signal that is received in response to the dummy data, and a transmission rate at which the dummy data is transmitted.

30. A method of transmitting downlink-quality information to a terminal station from a base station in a radio communication system, the method comprising:
transmitting periodically dummy data to a terminal station that is currently connected to the base station;
collecting downlink-quality information that is generated by transmitting the dummy data to the terminal station; and
transmitting the downlink-quality information collected at the collecting to the terminal station, based on which the terminal station determines whether to perform a handover.

31. The method according to claim 30, further comprising area monitoring including monitoring a data transaction between a second base station and a second terminal station that is a terminal station in a range capable of receiving a signal from the base station and currently connected to the second base station, wherein
the transmitting includes transmitting, when a data transaction between the second base station and the second terminal station is detected at the area monitoring, the dummy data to the second terminal station,
the collecting includes collecting downlink-quality information that is generated by transmitting the dummy data to the second terminal station, and
the transmitting includes transmitting the downlink-quality information collected at the collecting to the second terminal station, with which the second terminal station determines whether to perform the handover.

32. The method according to claim 30, wherein the downlink-quality information includes number of re-transmissions of the dummy data, an electric-power level of an acknowledge signal that is received in response to the dummy data, and a transmission rate at which the dummy data is transmitted.
